(19) United States
(12) Patent Application Publication
(10) Pub. No.: US 2025/0045529 A1
(43) Pub. Date: Feb. 6, 2025

(54) TRANSCRIPTION USING A CORPUS OF REFERENCE

(71) Applicant: International Business Machines Corporation, Armonk, NY (US)

(72) Inventors: Jeffrey Bisti, New Paltz, NY (US); Martin G. Keen, Cary, NC (US); Jeremy R. Fox, Georgetown, TX (US); Nageswara Sastry Renduchintala, Bengaluru (IN)

(73) Assignee: International Business Machines Corporation, Armonk, NY (US)

(21) Appl. No.: 18/228,914

(22) Filed: Aug. 1, 2023

(51) Int. Cl. G06F 40/40

(52) U.S. Cl. CPC G06F 40/40

(57) ABSTRACT

The illustrative embodiments provide for improved transcription accuracy using a corpus of reference information. An embodiment includes retrieving, using web-scraping, written content for a topic from a source. The embodiment also includes generating a corpus of reference material for a user using the written content. Generating the corpus of reference may include using a natural language processor. The embodiment also includes analyzing, an audio of a video for spoken content for a reference in the corpus of reference material; Where analyzing may include using a content analyzer. The embodiment also includes transcribing, using a transcription service, spoken content within an audio of the video. The embodiment also includes identifying, using the content analyzer, references in the transcription using a content analyzer. Where the content analyzer compares the spoken content to written content within the corpus. The embodiment also includes adding to the transcription text taken from the corpus of references.

### BACKGROUND

The present invention relates generally to transcriptions for videos. More particularly, the present invention relates to a method, system, and computer program for improving transcription of videos using a corpus of reference.

Videos have become a ubiquitous medium for communication, education, and entertainment, and their popularity is only increasing. Captions, in the form of SRT files, provide a means of making video content accessible to these viewers. The current state of the art for generating captions from video content relies on speech-to-text technology, which attempts to identify and transcribe spoken words from the audio portion of the video.

### SUMMARY

The illustrative embodiments provide for improved transcription accuracy using a corpus of reference information. An embodiment includes retrieving written content for a topic from a source. Retrieving written content may include web scraping. The embodiment also includes generating a corpus of reference material for a user using the written content. Generating the corpus of reference may include using a natural language processor. The embodiment also includes analyzing, an audio of a video for spoken content for a reference in the corpus of reference material; Where analyzing may include using a content analyzer. The embodiment also includes transcribing, using a transcription service, spoken content within an audio of the video. The embodiment also includes identifying, using the content analyzer, references in the transcription using a content analyzer. Where the content analyzer compares the spoken content to written content within the corpus. The embodiment also includes adding to the transcription text taken from the corpus of references. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example system for improving transcription accuracy in accordance with an illustrative embodiment;

FIG. 3 depicts a flow chart of an example method of improving transcription accuracy in accordance with an illustrative embodiment;

FIG. 4 depicts a flow chart of an example corpus of reference material builder in accordance with an illustrative embodiment;

FIG. 5 depicts a flow chart of an example speech-to-text transcription service in accordance with an illustrative embodiment;

FIG. 6 depicts a flow chart of an example content analyzer in accordance with an illustrative embodiment;

FIG. 7 depicts a flow chart of an example written content retrieval service in accordance with an illustrative embodiment; and

FIG. 8 depicts a flow chart of an example user input interface in accordance with an illustrative embodiment.

### DETAILED DESCRIPTION

Generating accurate transcripts for videos is a challenging task that has become increasingly important in today's digital age. Videos have become a ubiquitous medium for communication, education, and entertainment, and their popularity is only increasing. However, not all viewers are able to fully access the content of videos, particularly those who are deaf or hard of hearing. Captions, in the form of SRT files, provide a means of making video content accessible to these viewers. However, generating captions from video content is a difficult and error-prone process.

The current state of the art for generating captions from video content relies on speech-to-text technology, which attempts to identify and transcribe spoken words. However, this technology is far from perfect and often makes mistakes, particularly when dealing with technical terminology, acronyms, or proper nouns. This can lead to inaccurate captions that are difficult or impossible to understand. In addition, speech-to-text technology may also struggle with accents, dialects, or background noise, further reducing the accuracy of the generated captions.

As a result, there is a clear need for better solutions to the problem of generating accurate captions for video content. Such solutions must take into account the complex and varied nature of spoken language, as well as the diversity of video content available. They must also address the needs of a wide range of viewers, including those who are deaf or hard of hearing, as well as those who prefer to watch videos with captions for other reasons. Overall, the problem of generating accurate transcripts for videos is an important and challenging one that requires innovative and effective solutions.

The present disclosure addresses the deficiencies described above by providing a process (as well as a system, method, machine-readable medium, etc.) that generates accurate captions for video content using corpus of reference system leverages existing written content to improve transcription accuracy. The process and system are especially important in specialized fields that may include a lot of technical words. Video content often contains spoken portions that are taken directly from existing written material, such as technical documentation, articles, or books. By identifying and leveraging this existing written content, the accuracy of the captions generated from video content can be improved.

The system and application that is disclosed uses personalized written content references to improve the accuracy of transcriptions for video content. The system is designed to identify references to written content in a transcribed text output using techniques such as named entity recognition and information retrieval. The system then retrieves additional written content related to the identified references using web scraping and application programming interfaces (API) calls and applies natural language processing techniques to extract additional information and insights.

The system uses text alignment and clustering techniques to match the retrieved additional written content with the spoken content in the video and incorporates the retrieved content into a corpus of reference material used by the transcription service to generate more accurate written transcripts. The corpus of reference material may be personalized to the individual user. The system has potential applications in a wide range of industries, including education, entertainment, and corporate training, where accurate and reliable transcription of video content is critical for effective communication and information dissemination.

An illustrative embodiment includes developing a personalized corpus of reference material for each user's videos being transcribed. A user may include an individual or an organization. The corpus of reference material may contain written content that is most likely to be relevant to the content of the videos, such as, by non-limiting example, technical documentation, articles, or books on related topics. By using this corpus of reference material generated for the specific user, the system can more easily identify and transcribe words, phrases, and even entire sentences that are already written down elsewhere. This will improve the accuracy of the generated captions.

An illustrative embodiment includes a transcription application that leverages the corpus of reference material to identify and transcribe spoken content in videos. This transcription application identifies words, phrases, and sentences accurately from an audio portion of the video, when the words and phrases are technical or specialized. The transcription program uses and pulls from the relevant written content in the corpus as a reference. “Relevant” as referred to herein means appropriate to the content in the corpus of reference material.

The illustrative embodiments provide for improved transcription accuracy using corpus of reference. Technical as referred to herein is refers to a particular subject. A company may have manuals books, articles, and other technical documentation that is unique to the company or field of work. Embodiments disclosed herein describe transcribing the audio portion of an instructional video in written content; however, use of this example is not intended to be limiting but is instead used for descriptive purposes only. Instead, the improved transcription can be used for any sort of audio recordings that need to be transcribed. An audio recording may need to be transcribed to have a written record of the audio recording. The audio recording may need to be transcribed for those that are hearing impaired or even for those who prefer to read rather than listen to information.

A “corpus of reference material builder” as referred to herein builds a corpus of reference material for each individual or organization whose videos are being transcribed. The corpus of reference material includes written content that is most likely to be relevant to the content of their videos, such as technical documentation, articles, or books on related topics.

A “speech-to-text transcription service” as referred to herein uses the personalized corpus of reference material to better identify and transcribe spoken content in videos. The transcription service is able to identify words, phrases, and sentences accurately, even when they are technical or specialized in nature, by using the relevant written content in the corpus as a reference material.

A “content analyzer” as referred to herein identifies references to written content in the spoken content of audio portions of videos. The content analyzer compares the spoken content of a video to the written content in the corpus or reference material, identifies matches and uses this information to improve transcription accuracy. For example, the content analyzer may find new material in the spoken content of the video that is not already in the corpus of reference. The content analyzer will then use web scraping and other techniques to find new references that can be added to the corpus of reference material.

A “written content retrieval service” as referred to herein retrieves written content related to the spoken content of videos, such as technical documentation or social media posts. The written content is used to improve the accuracy of the generated captions. In some embodiments, the written content retrieval service retrieves additional written content from additional sources. In various implementations, there may be a second source, a third source, etc.

A “caption generation service” as referred to herein generates accurate captions for video content based on the identified spoken content and relevant written content. The captions can be provided in a variety of formats, including SubRip Subtitle (SRT) files.

Illustrative embodiments include creating a corpus of reference material for a software developer who frequently creates videos to explain technical concepts related to an internal transaction server. The software developer often runs into issues with the accuracy of automated transcriptions for his internal transaction server videos. The speech-to-text service he extensively uses frequently misidentifies technical terminology and proper nouns. This leads to errors in generating captions. The errors in the captions make it difficult for viewer to follow along with the content of his videos.

The software developer uses the corpus of reference material transcription application to improve the accuracy of his video captions. The application uses online documents, internal handbooks, and presentations to better identify and transcribe technical terminology and proper nouns accurately. The application also includes a content analyzer to identify references to written content in the software developer's videos and uses the corpus to improve accuracy of the transcriptions.

During the transcription process, the content analyzer identifies that the software developer has used a sentence word for word out of the internal handbook for production documentation. The improved transcription application is able to provide an accurate written transcript of the sentence used by the software developer which is then used to improve the overall accuracy of the generated captions. Using the improved transcription using a corpus of reference material, the software developer is able provide more accurate captions for his internal server videos making them more accessible to a wider audience.

Illustrative embodiments include improving transcription accuracy for a Java® programming tutorial video. (Java is a registered trademark of Oracle Corporation in the United States and other countries.) A developer often creates video tutorials explaining how to use various Java programming techniques and libraries. The accuracy of the automated transcriptions for his videos are often low which leads to errors in the generated captions. The inaccuracies make it difficult for viewers to follow along with the content of the videos.

The developer decided to use the corpus of reference-based transcription application to improve accuracy of the video captions. The transcription application uses a corpus of reference material including Java programming documentation, blog posts, and tutorial videos to better identify and transcribe technical terminology and proper nouns accurately. The application also includes a content analyzer to identify references to written content in the developer's videos and use the corpus of reference material to improve transcription accuracy.

During the transcription process, the content analyzer identifies that the developer has used several method names that are part of a Java library he maintains in a GitHub repository. GitHub is a cloud-based version control and collaboration platform for software developers. GitHub is owned by Microsoft Corporation. The improved transcription application as referred to herein is able to locate the relevant names in the repository's source code and retrieve the full code comment explaining how the method being described the developer works. This information is used to provide an accurate written transcript of the method names and associated documentation of the methods.

The content analyzer also identifies that the developer used a full sentence in a Tweet he posted about the same topic covered in the video. The sentence is retrieved from Twitter and used to improve the accuracy of the generated captions. (Tweet and Twitter are registered trademarks of Twitter, Inc. in the United States). Using the improved transcription application described herein the developer is able to provide more accurate captions for his Java programming tutorial videos, making the videos more accessible and helpful to other programmers.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

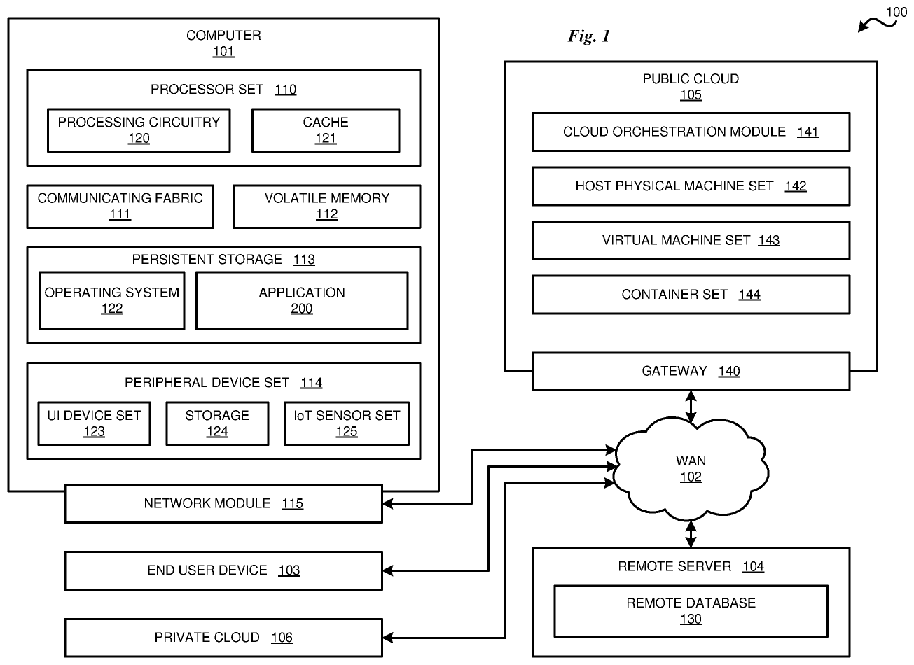

With reference to FIG. 1, this figure depicts a block diagram of a computing environment 100. Computing environment 100 contains an example of an environment for the execution of at least some of the computer code involved in performing the inventive methods, such as an improved transcription accuracy application using a corpus of reference material to improve transcriptions of videos on technical or highly specialized material. The corpus of reference material is generated specifically for a user. A user may be an individual or a company. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in application 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

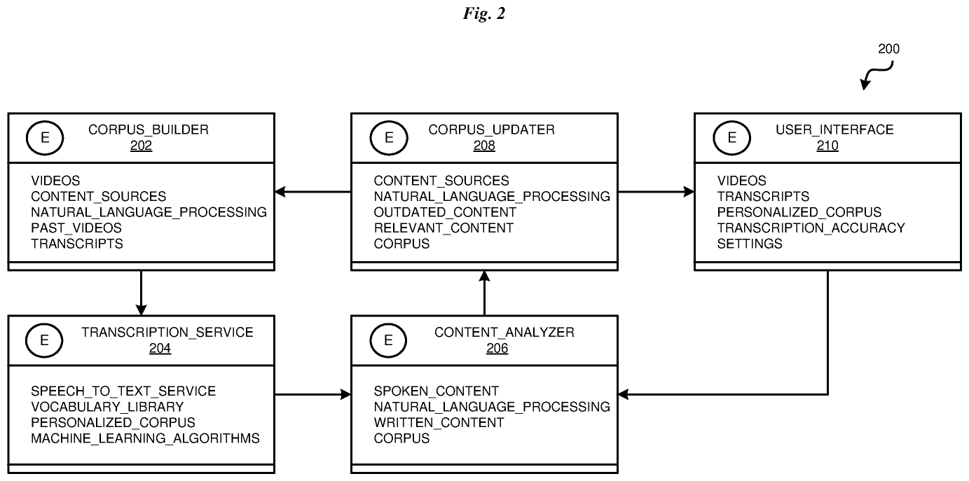

With reference to FIG. 2, this figure depicts a block diagram of an example improved transcription accuracy application 200 in accordance with an illustrative embodiment. In the illustrated embodiment, improved transcription accuracy application 200 includes the application 200 of FIG. 1.

In the illustrated embodiment, the improved transcription accuracy application 200 includes the entities that perform the improved transcription accuracy of audio portion of a video. The flow in this entity relationship diagram begins with the Corpus Builder 202, which is responsible for constructing the corpus of reference material for a user. The transcription service 204 then uses this corpus 202 in combination with a speech-to-text service and a vocabulary library to better identify and transcribe words, phrases, and sentences accurately.

The content analyzer 206 then analyzes an audio of a video for spoken content and identifies references to written content that already exist in the corpus of reference material. This information is used to update the corpus of reference material, using the corpus updater 208 by adding new sources of written content that are relevant to the user's video content and removing outdated or irrelevant content. The corpus updater may include a written retrieval service. The written retrieval service may retrieve additional written content related to the spoken content of videos, such as technical documentation or social media posts. The written retrieval content retrieval service may add additional written contect from a second source. In various embodiments, the written content retrieval service may add content from a third source and a fourth source, etc. The written content is used to improve the accuracy of the generated captions. The user interface 210 provides a way for users to interact with the system, including uploading videos for transcription, reviewing, and editing transcripts, and providing feedback on the accuracy of the transcriptions.

In the illustrated embodiment, the corpus builder 202 builds a corpus of reference material for each user whose videos are being transcribed. In various embodiments, a user may include an individual, a team of individuals, a company, or the like. The corpus includes written content that is most likely to be relevant to the content of their videos, such as technical documentation, articles, or books on related topics.

As described herein, the transcription service 204 uses the corpus of reference material to better identify and transcribe spoken content in videos. The transcription program is able to identify words, phrases, and sentences accurately, even when they are technical or specialized in nature, by using the relevant written content in the personalized corpus as a reference. In some embodiments, the transcription service may include a caption generation service. The caption generation service generates accurate captions for video content based on the identified spoken content and relevant written content. The captions can be provided in a variety of formats, including SRT files.

The content analyzer 206 analyzes the spoken content of videos to identify references to written content. The content analyzer 206 compares the spoken content of a video to the written content in the corpus of reference material, identifying matches and using this information to improve transcription accuracy.

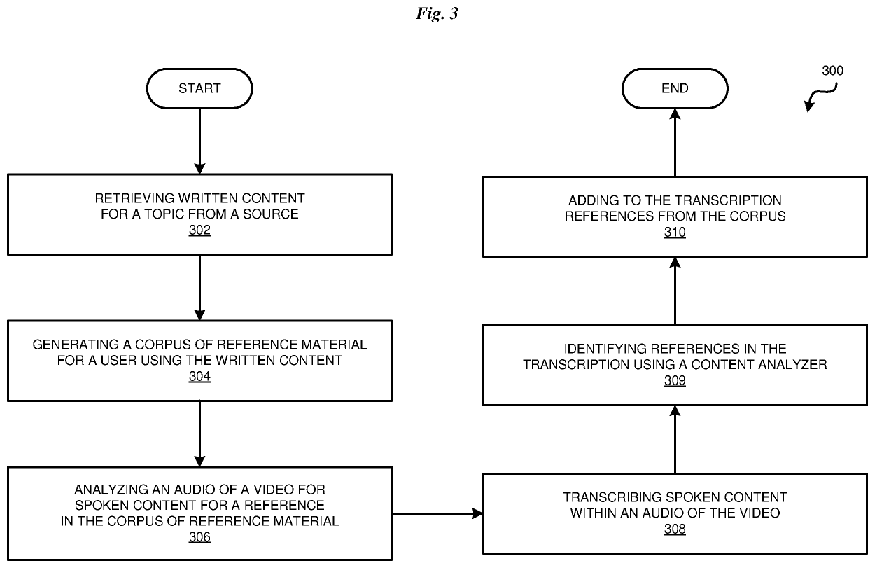

With reference to FIG. 3, this figure depicts a flow chart of a method of improving transcription accuracy using a corpus of reference material. In the illustrated embodiment, the method 300 is an example of the method performed by the application 200 of FIG. 1.

In the illustrated embodiment, the method starts with retrieving written content for a topic from a source 302. The written content may be supplied by a user through a user interface 210. The written content may include, by non-limiting example, reference materials internal to a company, training manuals, journal articles, transcriptions from previous videos and the like. In various embodiments, the written content may also contain material from the internet in general or specific websites. In some embodiments, the written content may contain information from social media accounts of an individual user or of the company. In various embodiments, the written content may be retrieved using web scraping techniques. The written content may also be retrieved, for example, using natural language processing (NLP) techniques.

In the illustrated embodiment, the method also includes generating a corpus of reference material for a user using the written content 304. The user may include, by non-limiting example, an individual, a team of individuals, or a company. The corpus of reference material may be personalized for the user. Generating the corpus of reference material may include retrieving a list of websites and online resources that are likely to contain relevant written content to the identified topic. Generating the corpus of reference material may include using clustering techniques to group similar text documents together based on identified key terms. Generating a corpus may also include assigning a weight to each text document based on its relevance to the identified topics.

Generating and updating the corpus of reference material may also include retrieving written content related to the identified references using web scraping and application programming interfaces (API) calls. The method may also include applying NLP techniques to extract additional information and insights.

In the illustrated embodiment, the method also includes analyzing an audio of a video for spoken content for a reference in the corpus of reference material 306. The application identifies references to written content text output using Named Entity Recognition (NER) and other information retrieval (IR) techniques. NER is a field of computer science and natural language processing that deals with the identification and classification of named entities in text. The method may also include applying text alignment and clustering techniques to match the retrieved written content with the spoken content in the audio of the video and incorporating the retrieved content into the corpus of reference material used by the transcription service.

In the illustrated embodiment, the method also includes transcribing spoken content within an audio of the video recording 308. Transcribing spoken content may include receiving the video file or uniform resource locator URL to be transcribed. Pre-processing techniques may then be applied to the audio, for non-limiting example, to reduce noise, equalize the volume, and sample rate conversion and the like. Transcribing the audio may include automatic speech recognition (ASR) technology such as deep learning models like Long Short-Term Memory (LSTM) networks or Transformer models to transcribe the spoken content of the video into written text.

Transcribing the spoken content also includes using the corpus of reference material to improve transcription accuracy. In various embodiments, transcribing the spoken content and improving transcription accuracy may include word substitution, language model adaptation, and acoustic model adaptation as will be described later in the application.

Transcribing the spoken content also includes post-processing techniques to the transcription output such as punctuation correction, capitalization, and spelling correction. Transcribing the spoken content also includes generating captions for the video based on the improved transcription output. The transcription may be provided in a large range of formats such as, by non-limiting example, SRT files or VTT files.

In the illustrated embodiment, the method also includes identifying references in the transcription using the content analyzer 310. Identifying references may include applying named entity recognition (NER) and other information retrieval (IR) techniques to the transcribed text from the transcription service. NER involves using machine learning algorithms to identify and classify named entities such as people, organizations, and product names in text. Information retrieval techniques can be used to identify relevant written content based on keyword searches and text similarity measures.

In the illustrated embodiment, the method may also include retrieving written content related to the identified references to improve the corpus of reference material. Written content may be retrieved using web scraping and API calls. For example, the component could scrape technical documentation from official websites or retrieve relevant social media posts using APIs like the Twitter API. (Twitter is a registered trademark of Twitter, Inc. in the United States, and other countries.)

In the illustrated embodiment, the method may also include adding to the transcription references from the corpus of reference material 310. Reference material from the corpus of reference material may be used to improve the transcription accuracy. Text alignment and clustering techniques may be used to match the retrieved written content with the spoken content in the video and incorporate the retrieved content into the personalized corpus used by the transcription service.

In the illustrated embodiment, the method includes generating captions for the video based on the improved transcription output and offering a range of formats for the transcription such as SRT files or VTT files. In various embodiments, the method may also include a user providing feedback on the accuracy of the transcription through a user interface.

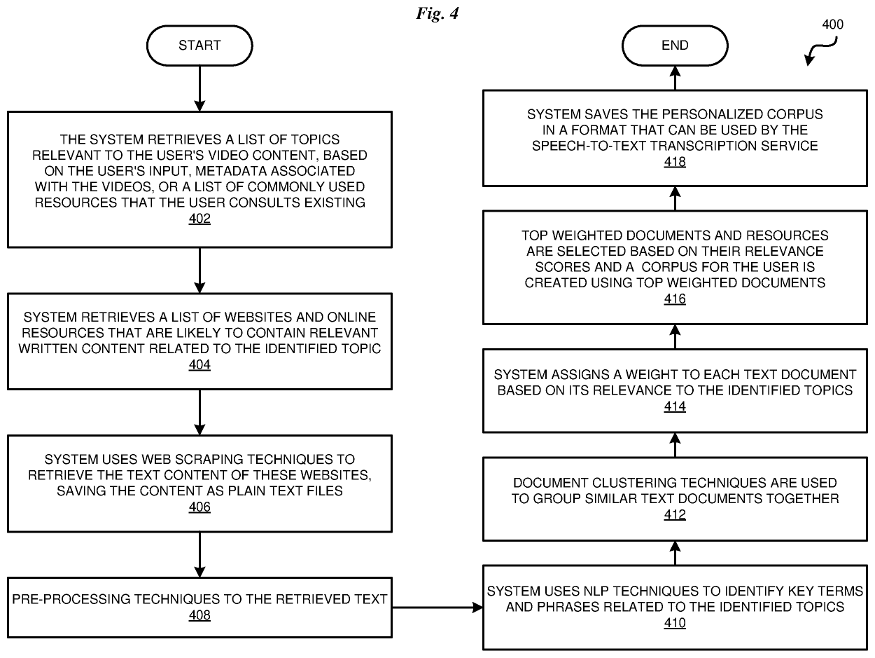

With reference to FIG. 4, this figure depicts a flow chart of an exemplary corpus of reference builder 400 in accordance with an illustrative embodiment. In the illustrated embodiment, the corpus of reference builder 400 is an example of the corpus builder 202 of FIG. 2.

In the illustrated embodiment, the corpus builder uses a combination of web scraping, NLP, and document clustering techniques to identify and retrieve relevant written content for a given set of topics, creating a corpus of reference material that can be used to improve transcription accuracy for video content. As illustrated, the system retrieves a list of topics that are relevant to the user's video content, based on the user's input, metadata associated with the videos, or a list of commonly used resources that the user consults existing 402. The system then retrieves a list of websites and online resources that are likely to contain relevant written content related to the identified topic 404.

In the illustrative embodiment, the system uses web scraping techniques to retrieve the text content of these websites, saving the content as plain text files 406. The system then applies pre-processing techniques to the retrieved text, such as stop word removal, stemming, and tokenization, and are used to prepare the text for further analysis 408. The system uses NLP techniques to identify key terms and phrases related to the identified topics, such as product names, technical terminology, and industry-specific jargon 410.

In the illustrative embodiment, document clustering techniques are used to group similar text documents together, based on the identified key terms and phrases 412. In various embodiments, the system assigns a weight to each text document based on its relevance to the identified topics, using measures such as term frequency-inverse document frequency (TF-IDF) or cosine similarity 414. Then the top N text documents are selected based on their relevance scores and a personalized corpus for the user is created, consisting of the selected documents 416. The system saves the personalized corpus in a format that can be used by the Speech-to-Text Transcription Service 418, such as, by non-limiting example, a collection of plain text files or a database of text documents.

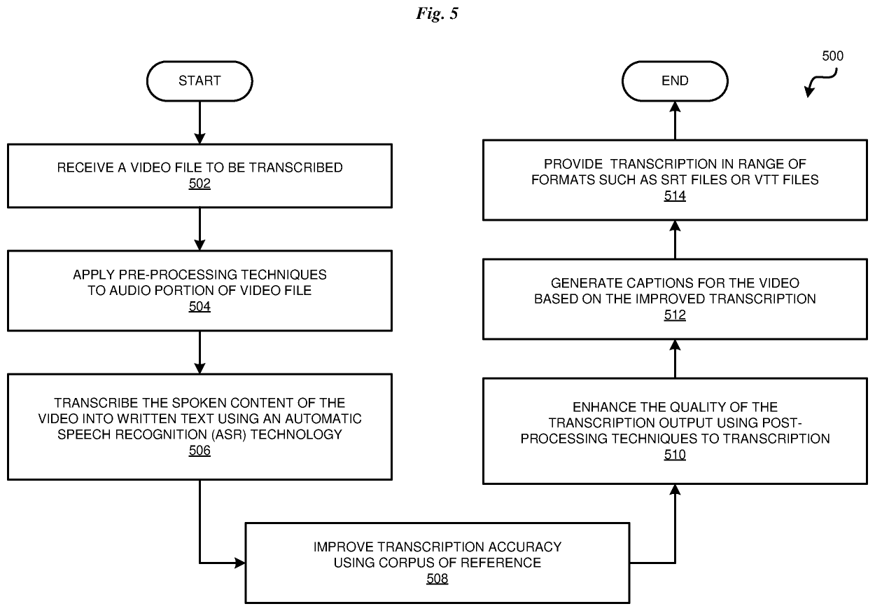

With reference to FIG. 5, this figure depicts a flow chart of a speech to text transcription service 500 in accordance with an illustrative embodiment. In the illustrated embodiment, the network management module 500 is an example of the transcription service module 204 of FIG. 2.

In the illustrated embodiment, the speech-to-text transcription service applies various techniques to the video file or URL, including pre-processing, automatic speech recognition (ASR), reference material adaptation, and post-processing. The service produces captions for the video, using the improved transcription output to provide greater accuracy.

In the illustrated embodiment, a service takes in a video file or a URL pointing to a video that needs to be transcribed 502. The service then applies pre-processing techniques 504 to the audio, such as noise reduction, equalization, and sample rate conversion. This step 504 is designed to enhance the quality of the audio and improve the accuracy of the transcription. For example, noise reduction can help to remove background noise from the audio, while equalization can balance the sound frequencies to make the audio more audible.

In the illustrated embodiment, the service uses automatic speech recognition (ASR) technology, such as deep learning models like Long Short-Term Memory (LSTM) networks or Transformer models, to transcribe 506 the spoken content of the video into written text. This step 506 involves using advanced machine learning algorithms to convert the spoken words in the video into written text.

In the illustrated embodiment, the service uses the personalized corpus of reference 508 material to improve transcription accuracy. The service employs techniques like word substitution, language model adaptation, and acoustic model adaptation. This step 508 involves comparing the transcribed text with the personalized corpus of reference material to identify and correct errors in the transcription. For example, if the transcription service misidentifies a technical term, the personalized corpus can be used to correct the term and improve the accuracy of the transcription.

In the illustrated embodiment, the service applies post-processing techniques to the transcription output 510. The post-processing techniques may include punctuation correction, capitalization, and spelling correction. This step 510 is designed to enhance the quality of the transcription output and make it more readable and accurate. For example, punctuation correction can help to add commas and periods to the transcription output, while capitalization can be used to capitalize proper nouns.

In the illustrated embodiment, the service then generates captions for the video based on the improved transcription output, offering a range of formats like SRT files or VTT files. The generated captions may then be analyzed by the content analyzer in various implementations. In other implementations, the generated captions may be sent to the user interface for review and feedback from a user.

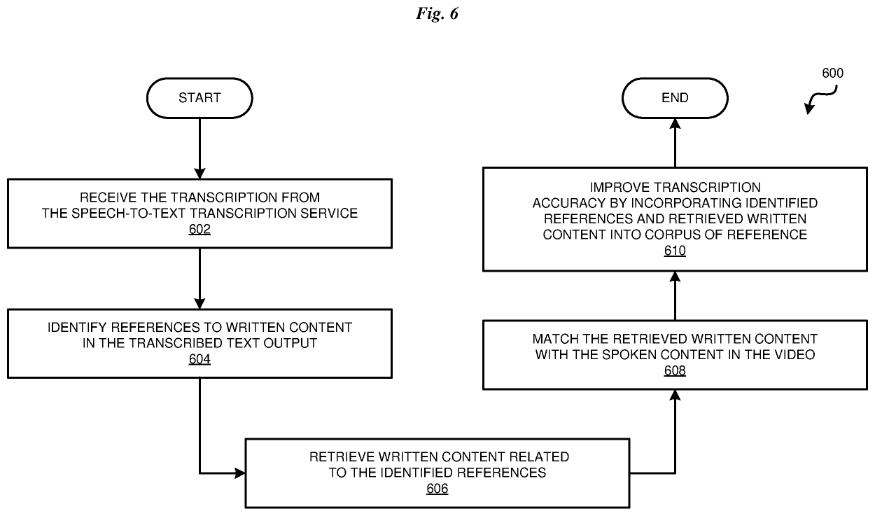

With reference to FIG. 6, this figure depicts a flow chart of an exemplary content analyzer entity 600 in accordance with an illustrative embodiment. In the illustrated embodiment, the content analyzer entity 600 is an example of the content analyzer entity 206 of FIG. 2.

In the illustrated embodiment, the content analyzer component uses a combination of NER. IR, web scraping, and text alignment/clustering techniques to identify and retrieve relevant written content related to the spoken content in a video. The identified references and retrieved written content can then be used to improve the accuracy of the transcription produced by the Speech-to-Text Transcription Service.

In the illustrated embodiment, the content analyzer receives the transcribed text from the speech to text transcription service 602. The content analyzer then identifies references to written content in the transcribed text output 604. The content analyzer identifies text by applying named entity recognition (NER) and other information retrieval (IR) techniques. NER involves using machine learning algorithms to identify and classify named entities such as people, organizations, and product names in text. IR techniques can be used to identify relevant written content based on keyword searches and text similarity measures.

In the illustrated embodiment, the content analyzer then retrieves written content 606 related to the identified references by web scraping and API calls. For example, the component could scrape technical documentation from official websites or retrieve relevant social media posts using APIs like the Twitter API.

In the illustrated embodiment, the content analyzer matches the retrieved written content with the spoken content 608 in the video using techniques like text alignment and clustering. Text alignment involves aligning the spoken content with the corresponding text content, while clustering techniques can group together similar text passages based on their content.

In the illustrated embodiment, the content analyzer uses identified references and retrieved written content to improve transcription accuracy 610 by incorporating them into the personalized corpus used by the Speech-to-Text Transcription Service. In various embodiments, the content analyzer may send the identified references to the corpus updater to be incorporated into the corpus of reference material for a particular user.

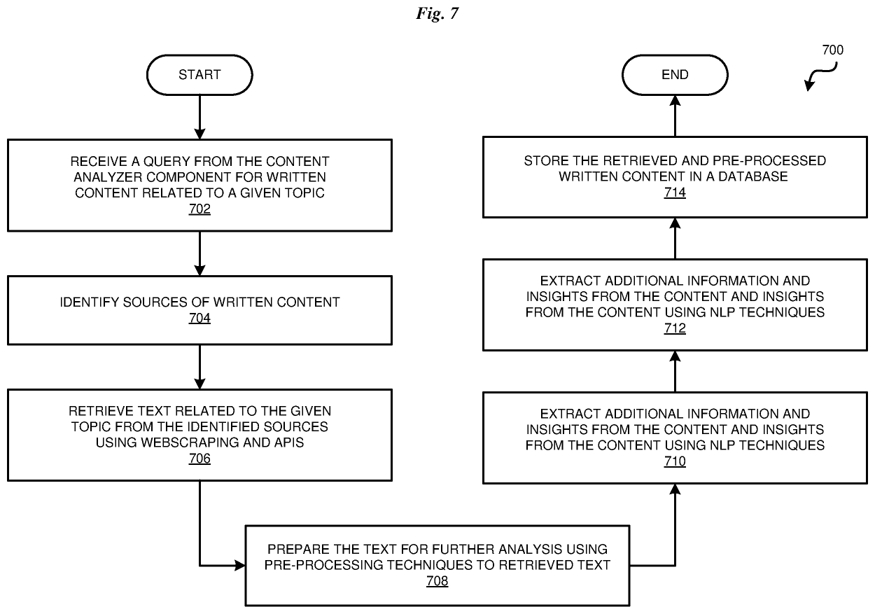

With reference to FIG. 7, this figure depicts a flow chart of an exemplary written content retrieval service 700 in accordance with an illustrative embodiment. In the illustrated embodiment, the written content retrieval service 700 may be used by the corpus builder 202 of FIG. 2.

In the illustrated embodiment, the written content retrieval service component 700 uses a combination of web scraping. APIs, NLP, and database/storage technologies to identify, retrieve, and store written content related to a given topic. The component can be used by the content analyzer component 206 to identify references to written content in the transcribed text output, improving transcription accuracy by incorporating the retrieved content into the personalized corpus used by the speech-to-text transcription service 204.

In the illustrated embodiment, a written content retrieval service 700 receives a query 702 from the content analyzer component 206 for written content related to a given topic. The written content retrieval service 700 identifies 704 potential sources of written content, such as online documentation, research papers, or social media platforms.

In the illustrated embodiment, the written content retrieval service 700 uses web scraping and APIs to retrieve written content 706 related to the given topic from the identified sources. For example, the component could scrape technical documentation from official websites or retrieve relevant social media posts using APIs like the Twitter API.

In the illustrated embodiment, the written content retrieval service 700 applies pre-processing techniques to the retrieved text 708. Pre-processing techniques may include, by non-limiting example, stopword removal, stemming, and tokenization, to prepare the text for further analysis.

In the illustrated embodiment, the written content retrieval service 700 applies NLP techniques to the retrieved text 710. Various NLP techniques may include, by non-limiting example, sentiment analysis, topic modeling, and entity recognition, to extract additional information and insights from the content.

In the illustrated embodiment, the written content retrieval service 700 stores the retrieved and pre-processed written content in a database or other data storage system 714. The written content retrieval service 700 also stores written content with metadata such as source information, timestamps, and content tags for retrieval of the content.

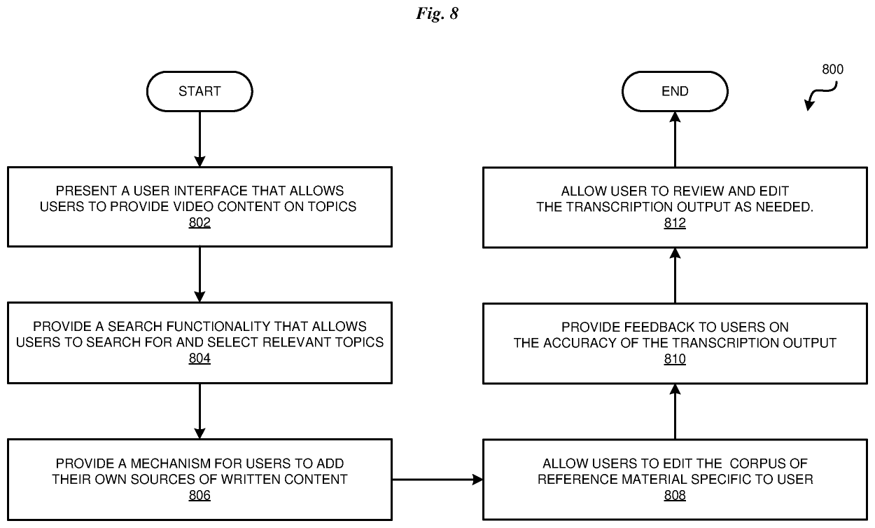

With reference to FIG. 8, this figure depicts a flowchart of an exemplary user input interface 800 in accordance with an illustrative embodiment. In the illustrated embodiment, the user input interface 800 corresponds with the UI device set of FIG. 1. In some embodiments, the user input interface component provides a user-friendly interface for users to specify their video content and customize their personalized corpus of reference material. The component allows users to add their own sources of written content, as well as review and edit the transcription output generated by the Speech-to-Text Transcription Service.

In the illustrated embodiment, a user is presented with the interface that allows users to specify their video content 802. In some embodiments, the user may provide other relevant information as well such as, by non-limiting example any known sources of written content related to that content. The user interface 800 also provides a search functionality 804 that allows users to search for and select relevant topics, such as product names or industry-specific jargon, to help personalize their corpus of reference material.

In the illustrated embodiment, the user interface allows users to edit the personalized corpus of reference material, adding or removing content based on their preferences and needs. In the illustrated embodiment, the user interface also provides feedback to users on the accuracy of the transcription output, allowing them to review and edit the output as needed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
retrieving, using web scraping, written content for a topic from a source;
generating, using a natural language processor, a corpus of reference material for a user using the written content;
analyzing, using a content analyzer, an audio of a video for spoken content for a reference in the corpus of reference material;
transcribing, using a transcription service, spoken content within an audio of the video into a text;
identifying, using the content analyzer, references in the text using a content analyzer, wherein the content analyzer compares the spoken content to written content within the corpus; and
adding to the text taken from the corpus of references.

2. The computer-implemented method of claim 1, further comprising updating the corpus of reference material by:
analyzing the text, using the content analyzer, for additional information to be added to the corpus of reference material;
retrieving additional written content from a second source based on the additional information in the text; and
adding the additional written content from a second source based on the additional information to the corpus.

3. The computer-implemented method of claim 1, wherein a user comprises an individual.

4. The computer-implemented method of claim 1, wherein the corpus of reference material comprises technical documentation, articles, and books.

5. The computer-implemented method of claim 1, wherein generating the corpus of reference comprises sourcing information from an internet source.

6. The computer-implemented method of claim 2, wherein updating the corpus of reference comprises adding material from a previous videos associated with a user.

7. The computer-implemented method of claim 1, further comprising presenting an interface to a user wherein the interface allows the user to edit the corpus of reference material and to provide feedback on an accuracy of the text.

8. The computer-implemented method of claim 1, wherein the written content is weighted using term frequency-inverse document frequency (TF-IDF).

9. The computer-implemented method of claim 1, wherein the written content is weighted using cosine similarity.

10. A computer program product comprising one or more computer readable storage media, and program instructions collectively stored on the one or more computer readable storage media, the program instructions executable by a processor to cause the processor to perform operations comprising:
retrieving, using web scraping, written content for a topic from a source;
generating, using a natural language processor, a corpus of reference material for a user using the written content;
analyzing, using a content analyzer, an audio of a video for spoken content for a reference in the corpus of reference material;
transcribing, using a transcription service, spoken content within an audio of the video into a text;
identifying, using the content analyzer, references in the text using a content analyzer, wherein the content analyzer compares the spoken content to written content within the corpus; and
adding to the text taken from the corpus of references.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
updating the corpus of reference material by:
analyzing the text, using the content analyzer, for additional information to be added to the corpus of reference material;
retrieving additional written content from a second source based on the additional information in the text; and
adding the additional written content from a second source based on the additional information to the corpus of reference.

13. The computer program product of claim 10, wherein generating the corpus of reference comprises sourcing information from an internet source.

14. The computer program product of claim 10, wherein the written content is weighted using term frequency-inverse document frequency (TF-IDF).

15. The computer program product of claim 10, wherein the written content is weighted using cosine similarity.

16. The computer program product of claim 10, further comprising presenting an interface to a user wherein the interface allows the user to edit the corpus of reference material and provide feedback on an accuracy of the text.

17. A computer system comprising a processor and one or more computer readable storage media, and program instructions collectively stored on the one or more computer readable storage media, the program instructions executable by the processor to cause the processor to perform operations comprising:
retrieving, using web scraping, written content for a topic from a source;
generating, using a natural language processor, a corpus of reference material for a user using the written content;
analyzing, using a content analyzer, an audio of a video for spoken content for a reference in the corpus of reference material;
transcribing, using a transcription service, spoken content within an audio of the video into a text; and
identifying, using the content analyzer, references in the text using a content analyzer, wherein the content analyzer compares the spoken content to written content within the corpus; and
adding to the text taken from the corpus of references.

18. The computer system of claim 17, further comprising updating the corpus of reference material by:
analyzing the text, using the content analyzer, for additional information to be added to the corpus of reference material;
retrieving additional written content from a second source based on the additional information in the text; and
adding the additional written content from a second source based on the additional information to the corpus of reference material.

19. The computer system of claim 17, wherein the written content is weighted using term frequency-inverse document frequency (TF-IDF).

20. The computer system of claim 19, wherein the written content is weighted using cosine similarity.
